(19) United States
(12) Patent Application Publication
(10) Pub. No.: US 2022/0110270 A1
(43) Pub. Date: Apr. 14, 2022

(54) SYSTEM AND METHOD FOR AUTOMATED FARMING OF POTTED PLANTS

(71) Applicant: ADVANCED INTELLIGENT SYSTEMS INC., Burnaby (CA)

(72) Inventors: Farhang Bidram, West Vancouver (CA); Shahram Pourazadi, Burnaby (CA); Saeed Mirazimi, Coquitlam (CA)

(21) Appl. No.: 17/422,386

(22) PCT Filed: Jan. 15, 2020
(86) PCT No.: PCT/CA2020/050039

§ 371 Date: Jul. 12, 2021

Related U.S. Application Data
(60) Provisional application No. 62/792,781, filed on Jan. 15, 2019.
(60) Provisional application No. 62/810,867, filed on Feb. 26, 2019.

(51) Int. Cl. A01G 9/14; A01G 9/00; A01G 9/08; G05B 15/02

(52) U.S. Cl. CPC A01G 9/143; G05B 15/02; A01G 9/08; A01G 9/006

(57) ABSTRACT

A system for automated farming of potted plants is disclosed and includes a closed-loop conveyor system configured to facilitate gradual cyclic mobility and storage of a plurality of potted plants. The system also includes at least one centralized processing zone disposed along the conveyor system and configured to perform at least one operation such as fertilization, irrigation, treatment, instrumentation, repotting, seeding, and inspection on each individual pot. The processing zone includes at least one sensor configured to detect at least one property of a potted plant. The system also includes a processing unit in communication with the at least one sensor, the processing unit configured to determine a state of each potted plant based on the at least one detected property. The state describes a physical state of the potted plant. The system also includes at least one loading station coupled to the conveyor system and configured to feed (input) potted plants to the conveyor system, and at least one unloading station coupled to the conveyor system and configured to unload (output) potted plants from the conveyor system.

### TECHNICAL FIELD

The subject matter disclosed herein relates to the technical field of automated farming particularly to automated farming for potted plants that require individualized attention.

### BACKGROUND

Robotic systems may be configured to carry out a certain task autonomously or semi-autonomously for a variety of applications. Recently a growing number of disclosures have focused on automating the task of farming and growth of potted plants.

The Europe Patent 0595431B1 uses conveyor lines and automated transporting shuttles to automate some of the processes in potted plant nurseries.

The U.S. Pat. No. 3,771,258A uses endless (closed-loop) conveyor system to improve farming of crops in palletized soil containers. There is one work area along the conveyor system wherein several processes such as seeding, irrigation, fertilization, and harvesting could be done on each crop container manually or using machines.

The U.S. patent Ser. No. 13/667,490 discloses an arrangement and method for automated cultivation of potted plants using a system of conveyor belts. However, the system proposes an open loop conveyor system for each plant's growth period (seeding, germination, and cultivation after germination) which requires very long conveyor lines with huge and very expensive infrastructure. Besides, the proposed solution suggests bulk irrigation and fertilization hydroponic systems.

### SUMMARY

In accordance with one disclosed embodiment, a farming solution for potted plants is proposed that essentially requires much shorter conveyor lines by using closed-loop conveyor systems that causes cyclic movement of potted plants during a growth period. In addition, aspects of the current disclosure propose processing zones to provide point (centralized) and individualized irrigation, fertilization, instrumentation, inspection and in general processing of each potted plant periodically within a growth period. In other words, in some disclosed aspects the complexities of processing infrastructures such as irrigation and instrumentation pipings are reduced by providing centralized processing, furthermore, providing the possibility for Selective and Individual treatment of each and every one of the potted plants.

This individualized method of processing for potted plants potentially increases the efficiency of farming by directing water, fertilizer, and pesticide to the right plant with the right amount. This method will potentially result in higher productivity of farms by reducing costs related to irrigation, fertilization, and pesticides and increasing the product yield. Individualized processing of each potted plant could potentially result in an improved yield of produce since each plant is inspected and treated individually for optimized growth. The conveyor system of the disclosed system improves accessibility of the potted plants for treatment and processing in the processing zones by transporting potted plants to the processing zones in a periodically.

The disclosed system provides the basis for fully automated and human-free farming of potted plants by using robotic processing stations. The system is particularly useful for plants that are expensive and require individualized treatment (such as Cannabis). Automation of the farming system using robotic processing stations also reduces or eliminates the need for interaction of human labor with the plants which in turn can reduce labor costs, reduce human-related infections and defects, reduce human theft from valuable plants and hence increase safety during a plant growth period.

Various aspects of automated farming systems and methods are described. In accordance with one disclosed aspect, a system for automated farming of potted plants is provided. The system includes a closed-loop conveyor system configured to facilitate gradual cyclic mobility and storage of a plurality of potted plants. The system also includes—at least one centralized processing zone disposed along the conveyor system and configured to perform at least one operation such as fertilization, irrigation, treatment, instrumentation, repotting, seeding, and inspection on each individual pot, the processing zone including at least one sensor configured to detect at least one property of a potted plant. The system also includes a processing unit in communication with the at least one sensor, the processing unit configured to determine a state of each potted plant based on the at least one detected property, wherein the state describes a physical state of the potted plant. The system also includes at least one loading station coupled to the conveyor system and configured to feed (input) potted plants to the conveyor system. The system also includes at least one unloading station coupled to the conveyor system and configured to unload (output) potted plants from the conveyor system.

The conveyor system may convey the potted plants in a cyclic manner and cause the potted plants to pass through the processing zone periodically. The conveyor system may move the potted plants continuously or intermittently and at different speeds depending on the type and the growth requirements of the potted plants. The conveyor system may have several elevation levels. The system may also include a lighting system such as controlled LED lightings disposed on the conveyor system and configured to provide suitable lighting for the plant's growth. The system may also include a temperature and humidity control system configurable to provide suitable temperature and humidity for the plant's growth. Each potted plant may be equipped with a unique identifier tag to assist tracking each plant and facilitate the individualized attention. The states of the potted plants may include “the beginning of a growth period”, “middle of a growth period”, “defective”, and “end of a growth period”. The processing zone may include one or both of at least one articulated robotic arm equipped with at least one end effector, and at least one processing station equipped with at least one end effector. Each end effector may be configured to perform a task on the potted plants. A tool changer station may be disposed near each robotic arm to provide different end effectors for the robotic arm. The robotic arm may autonomously couple with different end effectors to perform a variety of tasks on each potted plant. The processing station may be a tunnel along a conveyor line and various end effectors may be disposed on the inside of the tunnel to perform at least one process on each individual potted plant.

The system may also include networking hardware configured to facilitate communication between the processing unit and a server. The server may be a cloud-based server located at a remote facility. The cloud-based server may communicate with one or more farming systems. Data related to the processing of each potted plant may be transferred and collected on the server. The server may cause a controller to send command inputs to actuators of the processing zone to control the processing of each individual potted plant. A comprehensive record related to the processing of each potted plant during the growth period may be created and stored on the server. For a given type of plant during a designated growth period, an optimized growth pattern may be determined by the server by analyzing the processing records of a plurality of potted plants of one or more farming systems.

In accordance with another disclosed aspect, there is provided a multi-stage farming system for automated farming of potted plants using the above system for automated farming. The multi-stage farming system includes a plurality of the automated farming systems, each system configured for one or more stages in a plant's growth cycle. The multi-stage farming system also includes one or more processing facilities. The multi-stage farming system also includes a plurality of transport routes between the automated farming systems and processing facilities, the transport routes configured to carry potted plants. Each farming system may be configured to have different environmental parameters.

In accordance with another disclosed aspect there is provided a system for automated farming of potted plants. The system includes a closed-loop conveyor system configured to facilitate gradual cyclic mobility and storage of potted plants. The conveyor system includes a plurality of growing zones and a central processing zone. The system also includes a central processing device located in the central processing zone and configured to perform at least one operation such as fertilization, irrigation, treatment, repotting, seeding, and inspection on each individual potted plant. The processing device includes at least one sensor configured to detect at least one property of a potted plant. The system also includes a processing unit in communication with at least one sensor. The processing unit is configured to determine a state of each potted plant based on the at least one detected property, wherein the state describes a physical state of the potted plant. The system also includes at least one loading station coupled to the conveyor system and configured to feed (input) potted plants to the conveyor system and at least one unloading station coupled to the conveyor system and configured to unload (output) potted plants from the conveyor system. The conveyor system may transport a potted plant through the central processing zone before the plant is transported from a growing zone to a subsequent growing zone. Each growing zone may be configured to have different environmental parameters.

In accordance with another disclosed aspect there is provided a system for automated farming of potted plants with a shared central processing zone. The system includes a plurality of closed-loop conveyor systems. Each closed-loop conveyor system includes a growing zone and a processing zone. The system also includes one central processing unit disposed in a common area between the plurality of conveyor systems such that the processing can act as the processing zone of each of the conveyor systems. The system also includes at least one loading station configured to load potted plants to the plurality of conveyor systems and at least one unloading station configured to unload potted plants from the plurality of conveyor systems. The system may also include at least one loading station located on each closed-loop conveyor system or at least one central loading station located in the central processing zone configured to distribute potted plants among each closed-loop conveyor system.

In accordance with yet another disclosed aspect there is provided a method for automated farming. The method includes a loading step, a driving step, a performing step, a determining step, and an unloading step. In the loading step a plurality of potted plants whose state is beginning of a designated growth period are loaded at a loading station to a closed-loop conveyor system. In the driving step each potted plant on the conveyor system is driven to cycle through the closed-loop conveyor system. In the performing step, farming operations are performed on the potted plants while the pots are cycling through the conveyor system at at least one processing zone. The determining step involves determining, at the at least one processing zone, a state for each potted plant. The unloading step involves unloading, at an unloading station, a potted plant from the conveyor system based off of at least the determined state. The determined state may include that the plant is defective, and the method may also include identifying, by the processing unit, if there is any available treatment inside the processing zone for the defective plant. The method may also include performing the available treatment inside the processing zone on the defective plant if there is an available treatment. The method may also include determining, by the processing unit, once treatment is performed if the plant should continue cycling through the conveyor system. The method may also include unloading the defective potted plant from the conveyor system at an unloading station if there is no available treatment in the processing zone or if it is determined that the plant cannot continue cycling on the conveyor system despite treatment. The method may also include performing treatment on the defective plant outside the conveyor system and loading, at a loading station, the treated plant back into the conveyor system after successful treatment. The method may also include loading, at a loading station, further potted plants whose state is beginning or middle of a designated growth period, to a closed-loop conveyor system if the system has additional capacity. The conveyor system may be configured to convey the potted plants at speeds of about 0.5 centimeter per second, such that plants are not harmed or irritated. The performing step may also include attaching, by a robotic arm, to an end effector, engaging, by the robotic arm, with an incoming potted plant, performing, by the robotic arm, one or more tasks on the potted plant corresponding to the attached end effector of the robotic arm, and detecting, by a sensor on the robotic arm, at least a property of the potted plant. The determining step may also include identifying, by a processing unit, a state associated with a potted plant based on at least the detected property and assigning, by the processing unit, the identified state with an identifier of the potted plant.

According to yet another disclosed aspect there is provided a method for multi-stage automated farming system. The method involves preparing pots at a potting stage system. The method also involves transporting and loading the prepared pots to a sowing stage system, the sowing stage system configured to sow seedlings in the prepared pots. The method also involves unloading the sowed pots from the sowing stage system and transporting and loading the sowed pots to a growing zone of a first closed-loop conveyor growth stage system. The method then involves performing, at at least one processing zone of the first growth stage system, farming operations on the potted plants including determining a state for each potted plant. The method also includes unloading potted plants from the first growth stage system based off of at least the determined state. The method then includes transporting and loading potted plants to a growing zone of at least one other closed-loop conveyor growth stage system. The method also includes performing, at at least one processing zone of the at least one other growth stage system, farming operations on the potted plants including determining a state for each potted plant. The method then also includes unloading potted plants from each of the at least one other growth stage system based off of at least the determined state. The method also involves transporting each unloaded potted plant to a destination facility.

The method may also include transporting a potted plant to the potting stage system after unloading from a growth stage system. The method may also include repotting the potted plant at the potting stage system before transporting the potted plant to a growth stage system. The destination facility may be a harvesting stage system, and the method may also include harvesting the plant at the harvesting stage system, sending the harvested plants to a shipping and storage unit, and transporting and loading the remaining pots from the harvesting stage system back to potting stage system. The method may also include performing a first harvesting process on a potted plant in a processing zone of a growth stage system. The method may also include returning the potted plant to the at least one growing zone of the said growth stage system. The method may also include performing at least one other harvesting process on the potted plant, before unloading the pot from the said growth stage system.

According to yet another disclosed aspect there is provided a method for automated farming of potted plants using a conveyor system with an periodic conveying pattern. The method includes loading, at a loading station, a plurality of potted plants to a closed-loop conveyor system until before maximum capacity of the conveyor system is reached. The method then includes, for each plant, transporting the plant, by the conveyor system, through the first growing zone. The method then includes transporting the plant, by the conveyor system, through a central processing zone before transporting the plant to a next growing zone. The method then includes performing, at the central processing zone, one or more farming operations including determining, by a processor, a state for each potted plant. The method then includes determining, by the processor, if a potted plant should continue cycling through the conveyor system based on the determined state. The method then includes transporting, by the conveyor system, the potted plant through the next growing zone if the processor determines the plant should continue cycling through the conveyor system. The method then includes unloading each potted plant at an unloading station if the processor determines the plant should not continue cycling through the conveyor system.

Other aspects and features will become apparent to those ordinarily skilled in the art upon review of the descriptions of in conjunction with the accompanying figures.

### BRIEF DESCRIPTION OF THE DRAWINGS

In the following, embodiments of the present disclosure will be described with reference to the appended drawings. However, various embodiments of the present disclosure are not limited to the arrangements shown in the drawings.

FIG. 1 is a perspective view of a disclosed embodiment of an automated farming system;

FIGS. 2A and 2B are top and side views of the automated farming system of FIG. 1;

FIG. 3 is a perspective view, partially in close-up, of the processing zone of the automated farming system illustrated in FIG. 1;

FIG. 4 is a flowchart diagram showing an embodiment of the directions of operation of the system of FIG. 1;

FIG. 5A-5B are two perspective views of an embodiment of the robotic arms and a plurality of end effectors of the system in FIG. 1;

FIG. 6 is a block diagram view of another embodiment of an automated farming system;

FIG. 7 is a perspective view of an embodiment of a harvesting facility of FIG. 6;

FIGS. 8A-8C are perspective, plan, and side views of another embodiment of an automated farming system respectively;

FIGS. 9A-9B are perspective and plan views of yet another embodiment of an automated farming system; and

FIG. 10 is a block diagram view of a method for conveyor-based automated farming.

### DETAILED DESCRIPTION OF SPECIFIC EMBODIMENTS

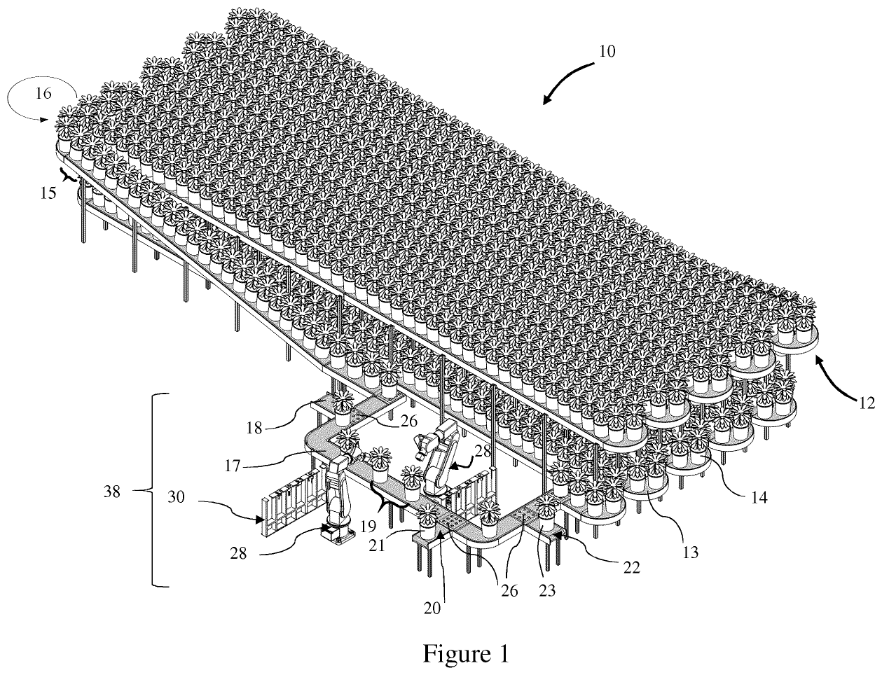

Referring to FIG. 1, a system for automated farming is generally shown at 10. The system 10 includes a closed-loop conveyor system 12 configured to move and store a plurality of potted plants 14, a processing zone 38, a loading station 18 for loading potted plants to the conveyor system 12, a first unloading station 20 and a second unloading station 22 configured to unload potted plants 23 from the conveyor system 12.

In the embodiment shown in FIG. 1, the conveyor system 12 comprises a plurality of conveyor belts (or lines) 13, each conveyor belt 13 is configured to move the pots in a predetermined direction and are connected such that the combined movement directions of the conveyor belts 13 results in an overall cyclic movement of the pots in a consistent pattern 16 around the conveyor system 12. The conveyor system 12 is further configured to convey each potted plant 14 in a cyclic path so that each potted plant 14 passes through the processing zone 38 once per cycle. In the embodiment shown in FIG. 1, the conveyor lines 13 are conveyor belts but in other embodiments conveyor chains, conveyor rollers, or other conveying systems may be used. The conveyor system 12 may carry each potted plant 14 on an individual carrier platform (not shown) on the conveyor belt 13.

The conveyor system 12 further includes at least one driver and power transmission system (not shown in figures) configured to move each conveyor belt 13 at a desired speed. The conveyor system 12 is further configured to move the conveyor belts 13 continuously or intermittently depending on the growth requirements of the potted plants. The potted plants are ideally moved on the conveyor lines 13 with speeds and acceleration that avoids harm or irritation to the plant. For example, in the case of Cannabis plants, the conveyor system 12 should move the plants at relatively slow speeds such as 0.5 centimeters per minute to avoid damage to the plants' roots systems and loss of buds, for example.

In general, the potted plants 14 are placed at a specific distance 15 from each other on the conveyor system 12 to allow space for growth of the potted plants. However, in the processing zone 38, the pots may be spaced at a different distance 19. In order to cause the difference in spacing distance 19 between the pots in the processing zone 38 and pots on the conveyor lines 13, the speed of the conveyor line 17 in the processing zone 38 may be different from the conveyor lines 13 in the non-processing zones (storage). In other embodiments, there may be a mechanism which allows for spacing adjustment, such as a stopper which controls pots moving into the conveyor line 17 processing zone 38 from the general conveyor lines 13, and/or the conveyor lines 13 may stop periodically, for example. The processing zone 38 is configured to perform one or more processes on potted plants 14 moving through the zone, and may include processing devices such as a robotic arm 28 to facilitate processing of each potted plant 14. In the embodiment shown in FIG. 1, the loading station 18 and the first 20 and second unloading stations 22 are embodied as conveyor belts coupled to the conveyor system 12 which may carry potted plants to or from the conveyor system 12. The conveyor system 12 may further include sorting mechanisms such as multi-directional conveying sections 26 configured to change the movement of articles in a desired direction in a selective manner, for example. In other embodiments, these stations may be additional robot arms, vertical lifts or chutes, or any other method of selectively adding or removing pots from the conveyor system.

Depending on the circumstances such as processing requirements associated with known parameters such as type and growth stage of the plurality of potted plants 14, and functional parameters such as the operating speed of the conveyor system 12 and space requirements of a facility the conveyor system 12 may be located in, some embodiments the farming system may include multiple processing zones (not shown in Figures) on the conveyor system 12, or aspects of the processing zone 38 may be distributed into multiple portions of the conveyor system 12. The conveyor system 12, or a portion of it such as the processing zone 38, may be preferably located in an indoor environment to facilitate a controlled environment, however in other embodiments may be located in an outdoor environment. The processing zone 38 is generally separate from conveyor lines 13, which allows the processing zone to easily be isolated from the bulk of the conveyor system 12. In cases such as when the plants are sensitive to outside contaminants and/or require clean room conditions, for example, the processing zone 38 can easily be isolated from the growing zones of the conveyor system 12 if maintenance or inspection needs to be carried out on the processing zone 38, such as by the inclusion of walls between the processing zone 38 and the bulk of the conveyor system 12, separated by airlocks for example.

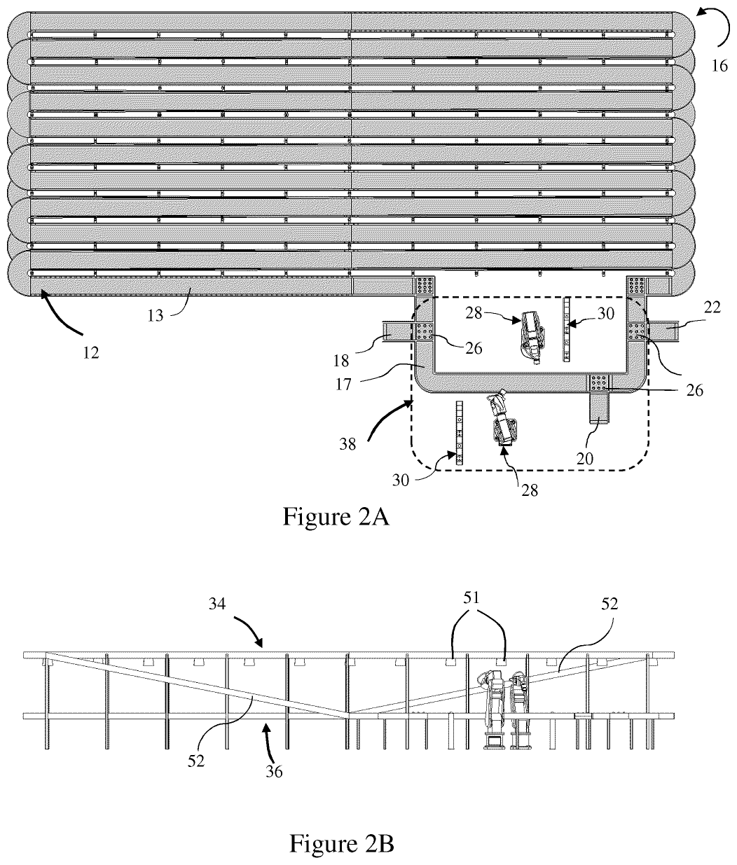

Referring to FIGS. 2A and 2B, top and side views of the system 10 where no pots are loaded to the conveyor system 12 are shown. Referring to FIG. 2A, a processing zone is generally shown at 38. As mentioned, the conveyor line 17 in the processing zone 38 may be configured to move at a different speed from other conveyor lines 13, for example, to facilitate a different distance between the pots. Referring to FIG. 2B, the conveyor system 12 may have two levels of elevation in order to improve efficiency in usage of the available floor space of a location, for example. Two levels of elevation of the conveyor system 12 are shown at 34 and 36 which are coupled together by means of two ramp conveyor belts 52. In other embodiments, the conveyor system 12 may have a single level of elevation, or three or more levels of elevation depending on the available floor space and desired density of plants, for example.

The system 10 is configured to provide the required lighting for the potted plants at the bottom level by means of artificial radiation lamps 51. The system 10 further includes a plurality of artificial radiation lamps disposed above the top level potted plants, such as ceiling lamps, (second-floor lightings are not shown in figures) to provide the lighting required for the potted plants of the top level. Alternatively, the lighting required for the growth of the plants can be supplied by means of natural light or a combination of natural light and artificial radiation lamps.

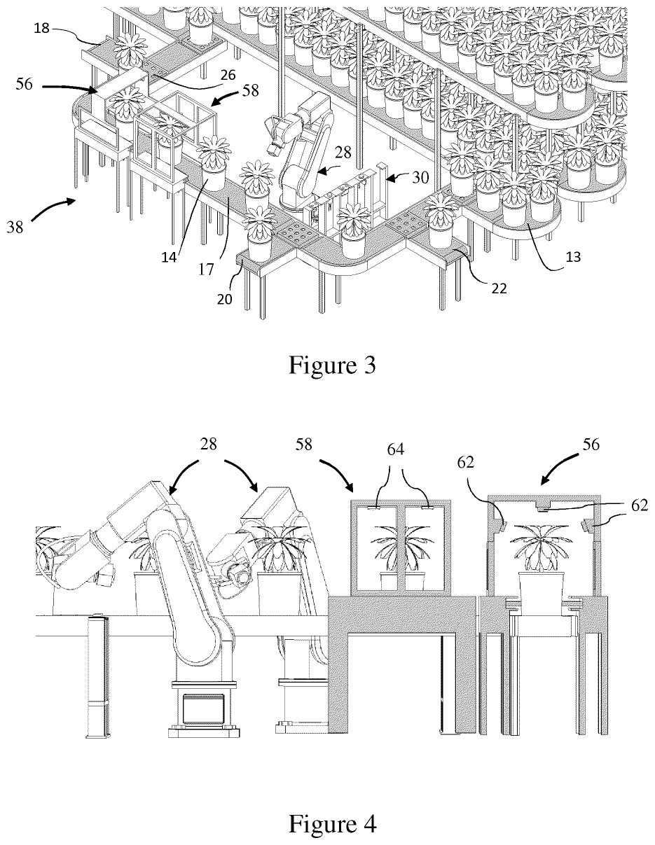

Referring to FIG. 3, a close-up perspective view of the processing zone is shown generally at 38. Within the processing zone 38, potted plants 14 may be added to the conveyor system 12 at the loading station 18. If there are vacant spots on the conveyor system 12, potted plants 14 may be fed into the conveyor system 12 through the loading station 18 and directed to the conveyor line 17 by means of a multi-directional conveying section 26.

The processing zone 38 includes one or more stationary robotic arms 28 configured to reach each potted plant 14 located on the conveyor belt 17 as it moves through the processing zone 38 to facilitate processing of each individual potted plants 14. The speed of the conveyor line 17 is configured in such a manner to provide sufficient time for comprehensive processing of each potted plant 14. The processing of potted plants may be performed with a combination of a stationary robotic arms 28 and inspection 56 and spraying 58 stations mounted along the conveyor line 17. The inspection station 56 is configured to inspect the potted plants by means of a plurality of cameras disposed on the station 56. The spraying station is configured to supply the potted plants with water and nutrients by means of a plurality of nozzles.

The processing zone 38 further includes tool changer stations 30 disposed within the reach of the robotic arms 28 and configured to provide a plurality of end effectors to the robot arms 28. A variety of different robotic end effectors such as vision camera, IR camera, gripper, trimmer, and sowing device may be located on the tool changer stations 30 for each robotic arm 28 in order to facilitate different modes of processing of the potted plants 14.

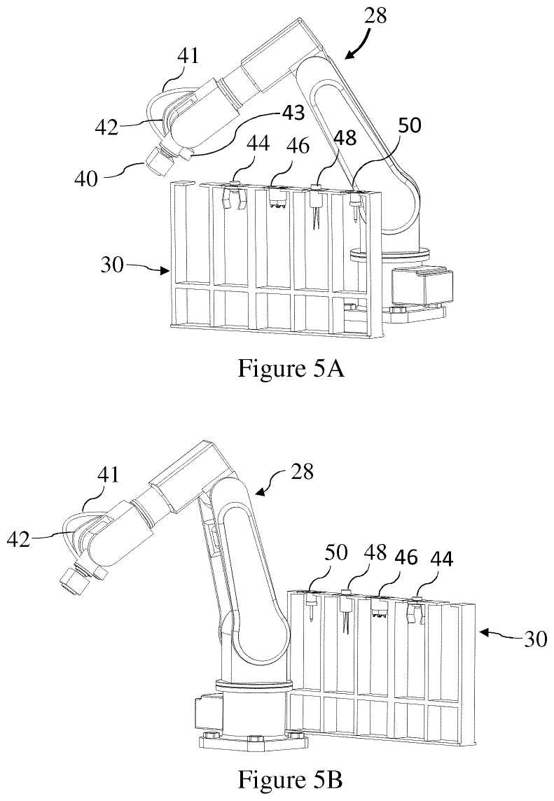

Referring to FIG. 4, a side view of an illustrative specific embodiment of the processing zone of the system is shown. In the embodiment shown, processing of potted plants is performed by means of a combination of two stationary robotic arms 28, an inspection station 56 and spraying station 58. The inspection station 56 is configured to inspect the potted plants (for example the surface temperature) by means of a plurality of IR cameras 62 disposed on the station. The spraying station is configured to supply the potted plants with water and nutrients by means of a plurality of nozzles 64.

In the processing zone 38 the robotic arms 28 or the inspection 56 and spraying 58 stations may perform a number of required processing steps individually or in combination—including but not limited to one or more of: inspection by means of IR cameras or vision cameras, sowing seeds by means of a sowing device, trimming by means of a trimming device and gripping device, fertilizing and irrigation by means of an injection device and spraying device. The robotic arms 28 or stations 56, 58 may further be configured to determine a state of each potted plant 14. The state may describe a physical status regarding each potted plant, for example. Examples of the assigned states to each potted plant 14 include “defective”, “start of the growth period”, “within the growth period”, and “end of growth period”. If the state of a potted plant is “start of the growth period” or “within the growth period”, the potted plant 14 may be returned to the conveyor line 13 outside of the processing zone 38 to further cycle through the conveyor system 12 and progress with the growth of the plant. If the state of the potted plant 14 is “defective”, however, the potted plant may be removed from the conveyor system 12 through a first unloading station 20. If the state of the potted plant is “end of the growth period”, the potted plant may be unloaded from the conveyor system 12 through a second unloading station 22, for example. Each unloading station such as the first 20 and the second 22 unloading stations may be connected by conveyors to different external facilities. For example, the first unloading station 20 may be connected to a disposal facility for disposing of defective plants, whereas the second unloading station 22 may be connected to a further processing facility such as a shipping or harvesting facility. In other embodiments, there may only be one unloading station such as the first unloading station 20 for removing plants from the conveyor system 12 and sorting may be done after the plants 14 are removed from the conveyor system 12. In the preferred mode of operation, potted plants 14 which are at the beginning of a designated growth period are loaded to the conveyor system 12 at a loading station 18 and are assigned the state “start of the growth period”.

The automated farming system 10 may further include networking hardware (not shown in figures) such as a router operably connected to various devices (such as sensors and actuators) of the system 10. The system 10 may also include a processing unit such as a microprocessor or a controller such as a central controller and/or server (not shown in figures) configured to receive electronic data, process the electronic data, make decisions such as determining the state of potted plants 14 based on the data, and/or sending command signals to the various devices. The networking hardware may facilitate communication of the system's devices with the central controller and/or server. The central controller may be configured to control the operation of the farming system and the central server may be mainly configured to oversee the processing data, for example. Both the central controller and the central server may be a local controller and server or a cloud-based controller and servers, or any combination thereof (such as a local controller and a cloud-based server, for example). A cloud controller and/or cloud server may be further configured to communicate with a plurality of different farming systems 10. The server may be configured to receive regular streams of data from sensors in the processing zone 38 regarding each potted plant 14, such as the state of a potted plant 14 as determined by the robotic arms 28 or stations 56 or 58, for example. This procedure may be made possible due to an identifier tag associated with each potted plant, such as a Radio-frequency identification (RFID) tag, a barcode or QR code, or a serial number for example. Sensory data related to each potted plant such as the amount of irrigated water and fertilizer, type of pesticide used, amount of nutrient in the potting medium, and appearance of the plant collected by robotic arms 28 and/or inspection 56 or spraying 58 stations of the processing zone 38 could be transferred to the server for storage an analysis.

On the other hand, the controller may be configured to send command signals to the actuators in the processing zone 38 to control a process such as trimming, amount of irrigated water and fertilizer sprayed for each potted plant 14 by the robotic arms 28 and/or inspection 56 or spraying 58 stations. Additionally, the controller may control the actuators of the conveyor system 12 driving the conveyor lines 13 and 17 to control the movement of pots 14 within the system 10, and/or to sort and direct pots to and from the loading 18 and unloading 20, 22 stations by the controlling multi-directional conveying sections 26, for example.

In the automated farming system 10, for each potted plant 14, a record of data related to the processing of the potted plant 14 may be created and stored on the server, wherein the record is updated each time the potted plant is passed through the processing zone 38. One skilled in the art can appreciate the value of the recorded data provided for each potted plant 14. The collected data, for example, could be used to track the growth of a plant and improve on the processes performed on the plant. A combination of data from a plurality of potted plants could be used to perform a study to optimize a processing pattern for the growth of a type of plant. For example, data related to the growth quality of a vast number of a particular plant with different amounts and durations of irrigation and fertilization could be consolidated on a local or cloud server and the data could be used to find an optimized pattern for irrigation and fertilization of the plant to yield an optimized growth. This optimization may be fed back into the controller of the system 10, in order to implement the optimization autonomously, for example.

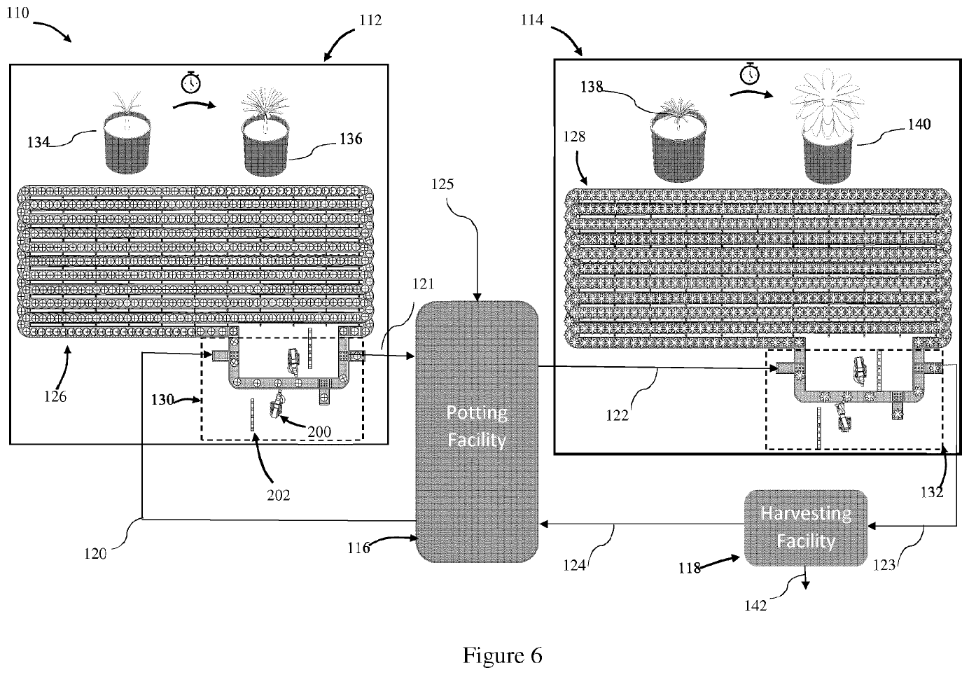

Referring to FIGS. 5A-5B, two perspective views of an example embodiment of a robotic arm 28 and tool changer station 30 for the system 10 are shown. The robotic arm 28 is equipped with an interface 40 configured to receive one of a number of end effectors, and includes a first hose 41 and a second hose 42 each configured to supply different fluid to certain end effectors. For example, the first hose 41 may carry compressed air for powering a pneumatic end effector, water for powering a hydraulic end effector, or may supply water to a spray nozzle, for example. Meanwhile, the second hose 42 may carry fertilizer or medicine for plants for example. The robotic arm 28 may also include a sensor 43 such as an optical camera in order to facilitate inspection of a potted plant.

The tool changer station 30 includes a plurality of replaceable end-effectors, each end-effector configured to facilitate a task or process on at least one potted plant and to attach to the robotic arm 28 through the interface 40. The plurality of end effectors on the tool changers station 30 may include a gripper or manipulator 44 for harvesting, pruning, or pot collection (by gripping the lips of a pot, for example), a nozzle 46 such as a double-headed nozzle configured to supply water and nutrients supplied through hoses 41 and 42, a trimmer or trimming head 48 configured to trim a plant, or an injection head 50 configured to inject water and nutrients supplied through hoses 41 or 42 into the growing medium (potting medium) of a potted plant, for example. The gripper or manipulator 44 may be pneumatically or hydraulically powered and may receive power supplied through hoses 41 or 42, or may be electrically powered and receive power through the interface 40, for example. In some embodiments, the plurality of end effectors may also include a variety of instruments configured to measure properties of the potted plants 14, such as a vision camera configured to inspect the potted plant, a sensor probe configured to measure properties of the potting medium nutrient and humidity levels or any other sensory devices configured to measure plant properties such as the plant's growth rate, produce yield level, and health, for example. The selection of end efforts at the tool changing station 30 may be configurable, and the selection available may be according to operational parameters of the farming system such as the needs of the plant based on type of plant and stage of plant growth, for example. The interchangeability of end effectors provided by the tool changing station 30 may allow the system to support growing a variety of plant types or plant pot sizes, such as in a nonhomogeneous growing facility for a collection of different plants with similar environmental requirements which individually may not have sufficient demand to fully load the automated farming system, for example. In another illustrative example, the system 10 may house pots of the same plant type but at different stages of growth due to similar environmental requirements at said stages, allowing the system 10 to be used efficiently even if there may not be enough plants at a single growth stage to fully populate the system 10. The tool changing station 30 may be configured to assist the robotic arm 28 in automatically changing the end-effector of the robotic arm 28, such as by having alignment mechanisms to aid the camera 43 in identifying the correct alignment or to mechanically self-correct small errors in alignment, for example.

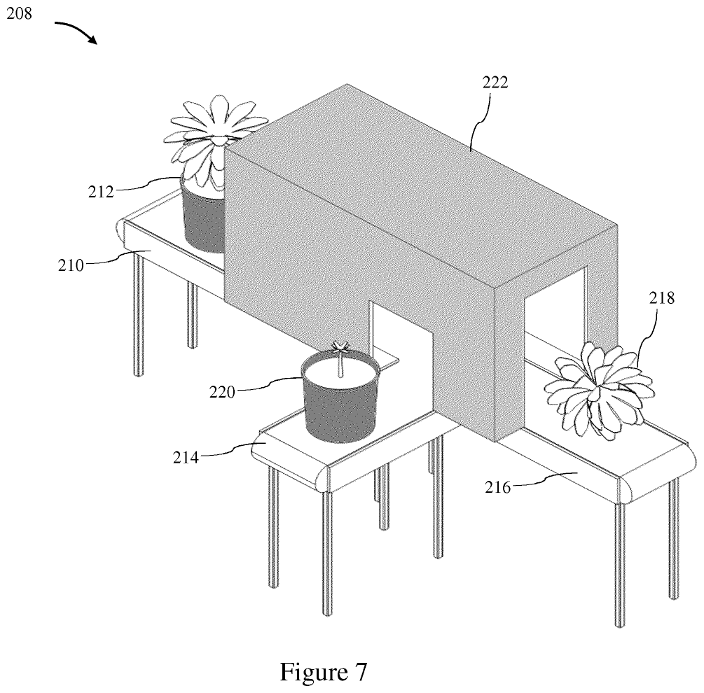

Referring to FIG. 6, an embodiment of a closed-loop system for automated multi-stage farming of a plurality of potted plants according to one disclosed aspect is generally shown at 110. The closed-loop farming cycle shown at 110 includes, for example, two plant growth stages 112 and 114, where each plant growth stage is configured to facilitate growth of a plurality of plants during a specific portion of the plant's life cycle. In one illustrative example, the first growth stage 112 may have a smaller spacing between the potted plants since the plants may be relatively small, whereas the second growth stage 114 may have a larger spacing between pots due to the larger size of grown plants. The second growth stage 114 may additionally provide larger vertical spacing for the plants. For some types of plants, the plants may grow relatively large and tall toward the end of the growth cycle, necessitating more horizontal distance between the plants as well as vertical support for plant stems. The automated multi-stage farming system shown at 110 may be configured to have more growth stages to facilitate the growth of potted plants in different stages according to the needs and growth properties of the specific type of plant, such as having a third, fourth or even more growth stages, for example. The system 110 further includes one or more facilities for handling of plants outside of growth stages 112 and 114, such as a potting facility 116 and a harvesting facility 118. The potting facility 116 is configured to prepare the pots and sow seedlings in the pots as well as facilitating repotting plants in pots with different sizes. The harvesting facility 118 is configured to perform a harvesting process on the potted plants. The system 110 further includes a plurality of connecting routes, such as routes 120, 121, 122, 123, and 124. The connecting routes 120, 121, 122, 123, and 124 are configured and connected in such a way as to convey pots from an origin to a destination by automatic means such as conveyor belts. In other embodiments, some or all of the connecting routes 120, 121, 122, 123, and 124 may instead be autonomous mobile robots which carry pots, or may be an autonomous tractor pulling carts which are loaded by a robotic arm, for example.

Each growing stage 112 and 114 is preferably operating in an indoor environment in order to facilitate control of the plant growth environment including factors such as lighting, humidity, and temperature. Each of the growing stages 112 and 114 includes a closed-loop conveyor system 126 and 128 respectively, each configured to facilitate storage and circulation of the pots. Each stage 112 and 114 further includes at least one processing zone 130 and 132 respectively, each configured to perform at least one process on the plants. Processes performed on the plants may be inspection, irrigation, pruning, fertilization, and harvesting by automatic means such as robotic arms 200, for example. Each plant growth stage 112 and 114 further include at least an input port to facilitate receiving pots and at least an output port to facilitate sending potted plants out. The input and output ports may be connected to one or more of the connecting routes 120, 121, 122, 123, and 124, for carrying pots to and from the potting facility 116, harvesting facility 118, or to or from another growing stage, for example.

In one illustrative embodiment, a first inter-stage facility is a potting facility 116 configured to perform one or more processes such as potting, repotting and sowing, preferably performed automatically by robotic arms or other autonomous devices, for example. The potting facility 116 is further configured to facilitate preparation of potted plants such sterilisation and filling pots with a growing medium, for example. The potting facility 116 may further be configured to perform a process of sowing for example sowing seedlings. Supply and raw materials such as growing medium, empty pots, fertilizers, and seeds or seedlings may be received at an input port in the potting facility 116 through an input route 125. Pots prepared by sterilisation, filled with growing medium, and sowed with seedlings may be directed to an output port of the potting facility 116 to be further transported to the input port of the growth stage system 112 through the connecting route 120.

The first growth stage system 112, referred to as the “first growth stage system” hereafter, is configured to facilitate processing and growth of a plurality of potted plants according to a first growth regiment. Generally, a plurality of potted plants which are at the “beginning of the first growth stage” state, as shown at 134, enter the first growth stage system 112 through an input port. The plurality of potted plants cycle through the conveyor system 126 of the first growth stage system 112 periodically. The potted plants undergo any required processing in the processing zone 130. Each potted plant cycles through the conveyor system 126 until the state of the potted plant changes from “within the first growth stage” state to the “end of the first growth stage” state. Potted plants which are at the “end of the first growth stage” state, as shown at 136, are removed from the conveying system 126 through an output port and are further transported to the next farming stage. In the embodiment shown in FIG. 6, the potted plants at the “end of the first growth stage” state are transported out of the first growth stage system 112 and into the potting facility 116, through the route 121 by automatic means such as conveyor belts.

Still referring to FIG. 6, the potting facility 116 is further configured to perform repotting of the potted plants. Repotting may include moving a plant and the corresponding growing medium contained within a pot to a larger pot in order to facilitate further growth of the potted plant, for example. Pots being repotted in the potting facility 116 may then be transported to an input port of the second growth stage system 114 through a connecting route 122.

The second growth stage system 114, referred to as the “second growth stage system” hereafter, is configured to facilitate processing and growth of a plurality of potted plants according to a second growth stage regiment. Repotted plants at the state “beginning of the second growth stage” shown at 138 enter the second growth stage system 114. The plurality of potted plants cycle through the conveyor system 128 of the second growth stage system 114 periodically. The potted plants undergo any required processing such as irrigation, inspection, fertilization, and trimming in the processing zone 132. Each potted plant cycles through the conveyor system 128 until the state of the potted plant changes from “within the second growth stage” state to the “end of the second growth stage” state as shown at 140. Potted plants at the “end of the second growth stage” state 140, are removed from the conveying system 128 of the second growth stage system 114 through an output port and transported to the next farming stage. In the embodiment shown in FIG. 6, the potted plants at the “end of the second growth stage” state are transported out of the second growth stage system 114 and into a harvesting facility 118 through a route 123 by automatic means such as conveyor belts. In other embodiments, more than two growth stages may be needed for the plant before the potted plant is transported to a harvesting facility 118, and the plants removed from the second growth stage system 114 may instead be transported to a third growth stage system and so on, for example.

The harvesting facility 118 is configured to harvest the potted plants which are at the “end of the second growth stage” state and are suitable for harvesting. The harvesting facility 118 includes an input port configured to receive potted plants through connecting route 123. The harvesting facility 118 further includes an output port for sending out harvested products to a destination facility such as a shipping facility through connecting route 142. Harvesting may be carried out autonomously by a device such as an automatic harvester or a robotic arm, for example.

In other embodiments, harvesting may be one of the processes carried out in the processing zone 132 of the second growth stage system 114. This configuration facilitates harvesting of potted plants which require multiple harvesting stages within a single period of growth, for example. The harvesting facility 118 may further include another output port to facilitate sending out the remaining pots from the harvested potted plants back to the potting facility 116 through a route 124. In other embodiments, the remaining pots from the harvested potted plants may be discarded.

Each of the first 112 and second 114 growth stage systems may be a system for automated farming similar to system 10 of FIG. 1, for example. An input port of the first growth stage system 112 may be similar to a loading portion 18 of FIG. 1, for example, and be connected to connecting route 120 which leads from the potting facility 116. An output port of the first system 112 may be similar to an unloading station such as station 22 of FIG. 1, and be connected to connecting route 121 which leads back to the potting facility 116 for example. Similarly, an input port of the second growth stage system 114 may also be similar to a loading portion 18 of FIG. 1 and be connected to connecting route 122. An output port of the second system 114 may be similar to an unloading station such as station 22 of FIG. 1, and be connected to connecting route 123 which leads to a harvesting facility 118. Each of the first 112 and second 114 growth stage systems has a second output port which may be similar to an unloading station such as station 20 of FIG. 1 for disposal of defective plants, for example. In some embodiments, a second output port of the second system 114 may be similar to an unloading station such as station 20 of FIG. 1 and be connected to connecting route 124 which leads back to the potting facility 116, for example.

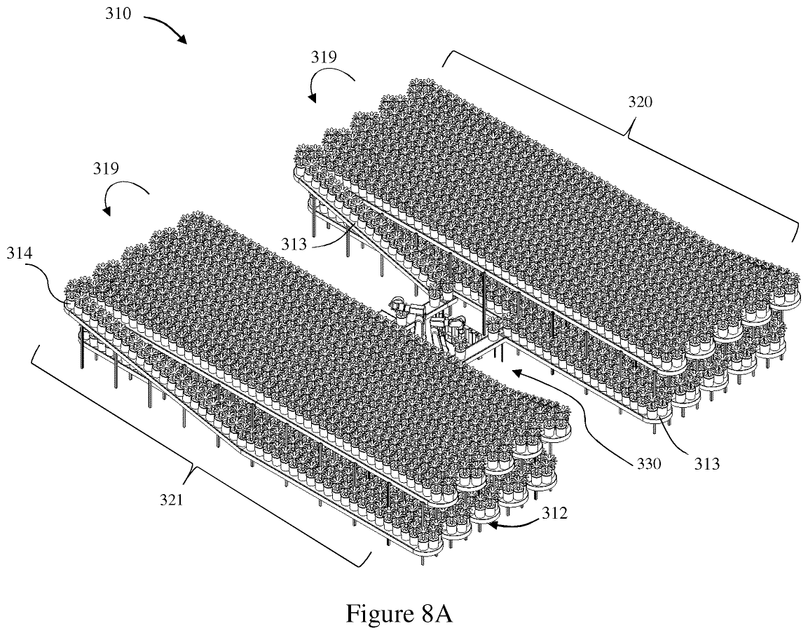

Referring to FIG. 7, an embodiment of the harvesting facility 118 of system 110 of FIG. 6 is generally shown at 208 in a perspective view. The facility 208 includes one input port 210 configured to receive potted plants 212 that are suitable to undergo a harvesting process. The harvesting facility further includes two output ports 214 and 216. The output port 216 is configured to facilitate sending out harvested products 218 to be further transported to a destination facility such as a shipping facility for example. The output port 214 is configured to facilitate sending out harvested pots 220 to another facility such as the potting facility 116 of FIG. 6 or to a disposal facility to discard unwanted plants. The harvesting compartment 222 is configured to facilitate harvesting the potted plants by automatic means such as cartesian robots with changeable end effectors for example. The compartment 222 may be configurable to facilitate different types of harvesting such as picking (for example for plants that have a fruit produce such as tomatoes) by means of a gripper end effector and pruning (for example for plants that require pruning such as peppers) by means of a pruning device.

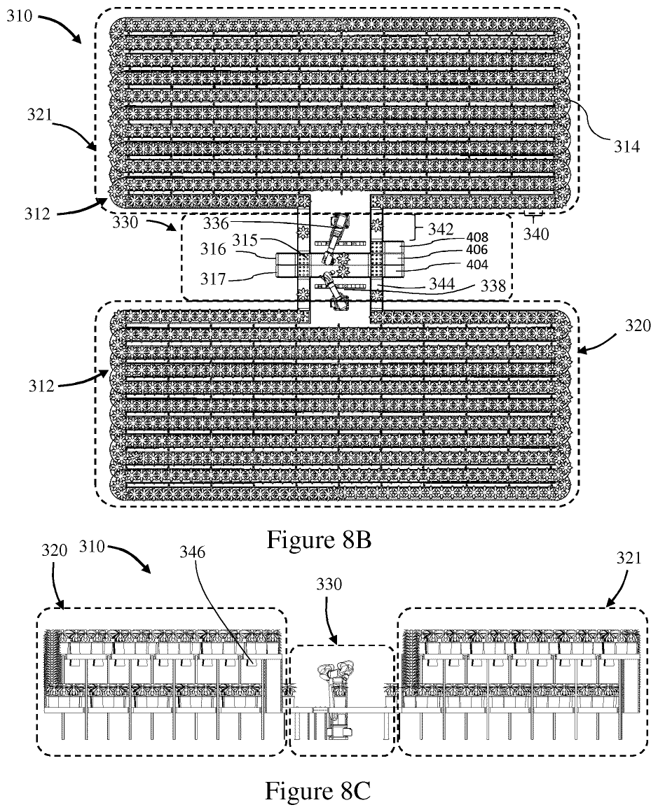

Referring to FIG. 8A, a system for automated farming of a plurality of potted plants is shown generally at 310. The system 310 includes a closed-loop conveyor system 312 configured to move and store a plurality of potted plants 314, a loading station 316 (shown in FIG. 8B) configured to facilitate feeding potted plants 314 to the conveyor system 312, specially at the beginning of the designated growth stage, a first unloading station 317 to facilitate removing defective potted plants from the conveyor system 312, and a second unloading station 318 configured to unload potted plants 314 that are at the end of a designated growth period from the conveyor system 312.

The conveyor system 312 further includes two growing zones—a first growing zone 320 and a second growing zone 321—each configured to gradually move each potted plant 314 to facilitate the plant growth according to a designated growth stage and a central processing zone 330 disposed between the growing zones 320 and 321 and configured to perform at least one process on the potted plants.

The conveyor system 312 conveys each potted plant 314 in a generally cyclic path. In some embodiments, within a single cycle, each potted plant 314 travels through the first growing zone 320, through the central processing zone 330, through the second growing zone 321, through the central processing zone 330 again, and back to the first growing zone 320. In other words, during each cycle, a potted plant 314 passes through the processing zone 330 twice. In other embodiments, plants 314 in the first growing zone 320 may move through the central processing zone 330, then back to the first growing zone 320, while plants 314 in the second growing zone 321 move through the central processing zone 330 and back to second growing zone 321. In yet other embodiments, some potted plants 314 may move from the first growing zone 320 through the processing zone 330 to the second growing zone 321 and vice-versa, while others return to the growing zone from which they originated after moving throw the processing zone 330. In either case, a potted plant 314 moves through the processing zone 330 after it has moved through either growing zone 320 or 321.

In the embodiment shown in FIG. 8A, the conveyor system 312 comprises a plurality of conveyor belts, each conveyor belt 313 is configured to move the pots in a distinct direction. Overall, the movement direction of the conveyor belts is in such a way to cause cyclic movement of the pots in a generally counterclockwise direction 319 through the conveyor system 312.

The conveyor system 312 further includes at least one driver or actuator and power transmission system (not shown in figures) configured to move each conveyor belt. The driver may be adjustable to move each conveyor belt 313 at a desired speed. The conveyor system 312 is further configured to move the conveyor belts 313 continuously or intermittently depending on defined parameters such as the growth requirements of the potted plants 314 for example. The potted plants 314 should ideally be moved on the conveyor lines at speeds and with acceleration such that harm or irritation to the plant is avoided. For example, in case of Cannabis plants, the conveyor system 312 should move the plants at relatively slow speeds such as about 0.5 centimeter per minute to avoid damage to the plants' roots and losing buds.

Referring to FIGS. 8B and 8C the system 310 is shown in top and side views. Referring to FIG. 8B, the growing zones are generally shown at 320 and 321 and the central processing zone is generally shown at 330. In general, the potted plants 314 are disposed at a specific distance 340 from each other on the conveyor system 312 to facilitate the growth of the potted plants. However, in the processing zone 330, the pots may be configured to transport at a different distance 342. In order to cause a different distance 342 between the pots in the processing zone 330, the speed of the conveyor line 344 in the processing zone 330 could be different from the conveyor lines 313 in the growing zones 320 and 321, for example, or another mechanism for adjusting the distances may be used such as a mechanical stopper combined with intermittent motion, or respacing by a robotic arm.

In some embodiments, the processing zone 330 may be substantially similar to the processing zone 38 of FIG. 1, for example. The processing zone 330 includes one or more stationary robotic arms 336 configured to reach each potted plant 314 disposed on the conveyor belt 344 as the plants 314 pass through the processing zone 330 in order to facilitate processing of individual potted plants. The speed of the conveyor line 344 is configured in such a manner to provide sufficient time for comprehensive processing of each potted plant 314 using the robotic arms 336. The processing zone 330 may further include a plurality of tool changer stations 338 disposed within the reach of the robotic arms 336 and configured to provide a plurality of end effectors. End effectors such as vision camera, IR camera, gripper, trimmer, and sowing device may be located on the tool changer stations 338 for each robotic arm 336 in order to allow the robotic arms 336 to perform a variety of processes on the potted plants 314 as necessary.

In the central processing zone 330, the robotic arms 336 perform processing steps including but not limited to inspection by means of IR cameras or vision cameras, sowing seedlings by means of a sowing device, trimming by means of a trimming device and gripping device, fertilizing and irrigation by means of an injection device and spraying device. The robotic arms 336 may further be configured to determine and assign a state to each potted plant 314. The assigned states describe a physical status regarding each potted plant. Examples of the assigned states to each potted plant 314 include “defective”, “start of the growth stage”, “within the growth stage”, and “end of the growth stage”. If the state of a potted plant is “start of the growth stage” or “within the growth stage”, the potted plant 314 is returned to the conveyor line 313 outside of the processing zone 330 to further cycle through the conveyor system 312 and progress with the growth of the plant. If the state of the potted plant 314 is “defective”, the potted plant is eliminated from the conveyor system 312 through the elimination station 317. If the state of the potted plant is “end of the growth stage”, the potted plant is unloaded from the conveyor system 312 through the unloading station 318.

In the embodiment shown in FIG. 8B, the loading station 316, the elimination station 317, and the unloading station 318 are shown as conveyor belts coupled to the conveyor system 312 in the central processing zone 330. In other embodiments, these stations may be additional robot arms, vertical lifts or chutes, or any other method of selectively adding or removing pots from the conveyor system.

Referring to FIG. 8C, the conveyor system 312 has two levels of elevation in order to improve efficiency in use of the available space. In other embodiments, the conveyor system 312 may have a single level of elevation, or three or more levels of elevation depending on the available floor space and desired density of plants, for example.

The system 310 is configured to provide the required lighting for the potted plants by means of a plurality of artificial radiation lamps 346. The system 310 includes a plurality of artificial radiation lamps disposed above the top level potted plants (second-floor lightings are not shown in figures) to provide the lighting required for the potted plants of the top level. Alternatively, the lighting required for the growth of the plants can be supplied by means of natural light or a combination of natural light and artificial radiation lamps.

Depending on the circumstances such as type and growth stage of the plurality of potted plants, and also the speed of the conveyor system, the farming system may include more than one processing zones (not shown in the Figures) mounted on each the conveyor system of a growing zone to improve the processing of the potted plants. Although multiple processing zones might be used along the conveyor system 312, the transport structure of the conveyor system facilitates periodic and frequent processing of each potted plants using only the central processing station 330.

Referring back to FIG. 8B, the automated farming system 310 can be configured to operate in two different configurations. In the first configuration the potted plants 314 move between the first growing zone 320 to the second growing zone 321 and back, passing through the processing zone 330 each time the potted plants 314 moves from one growing zone to another. In other embodiments, each of the first 320 and second 321 growing zones is a closed-loop conveyor system wherein each closed-loop conveyor system is configured to facilitate cycling a plurality of potted plants within each conveyor system. Both growing zones 320 and 321 share a common processing zone 330. This configuration potentially results in less need for processing infrastructure by sharing a common processing unit between multiple farming systems.

In this embodiment, loading station 316 and unloading station 317 may both be loading stations coupled to the conveyor systems 320 and 321 respectively to facilitate loading potted plants to each corresponding conveyor system (for example, by running unloading station 317 in reverse). New unloading stations 404 and 406 may be coupled to the conveyor systems 320 and 321 respectively to facilitate unloading potted plants from each corresponding conveyor system. A shared elimination station 408 may be coupled to both conveyor systems 320 and 321 to facilitate eliminating potted plants whose state is defective, for example. In this embodiment potted plants that are loaded on the first conveyor system 320 might be different or similar to the potted plants that are loaded on the second conveyor system 321. In some cases, potted plants 314 may be moved from one conveyor system to the other as part of processing in the processing zone 330, which may be controlled through the use of multi-directional conveyors 315, for example. For example, the first conveyor system 320 may be for plants in a first stage of growth, the stage being relatively early in the plant's life cycle, while the second conveyor system 321 may be for plants in a second stage of growth, the stage being relatively later in the plant's life cycle. When a plant is determined during processing in the processing zone 330 to have reached the second stage of growth, it may be transferred from the first conveyor system 320 to the second conveyor system 321, whereas plants that have not yet reached the second stage of growth are instead returned to the first conveyor system 320.

The automated farming system 310 may further include networking hardware (not shown in figures) such as a router operably connected to the devices (sensors and actuators) of the system 310. The networking hardware may facilitate communication of devices of the system 310 with a central controller and/or a central server (not shown in figures) in a substantially similar manner as described above with reference to FIG. 4, for example. Additionally, the cloud server may keep a record of the potted plants in each conveyor system 320 and 321, for example, and may instruct the controller on how to 314 handle potted plants 314 such as whether or not to keep a plant in a conveyor system, transfer it to another conveyor system, unload the plant for repotting or harvesting, or eliminated the plant due to defects, for example.

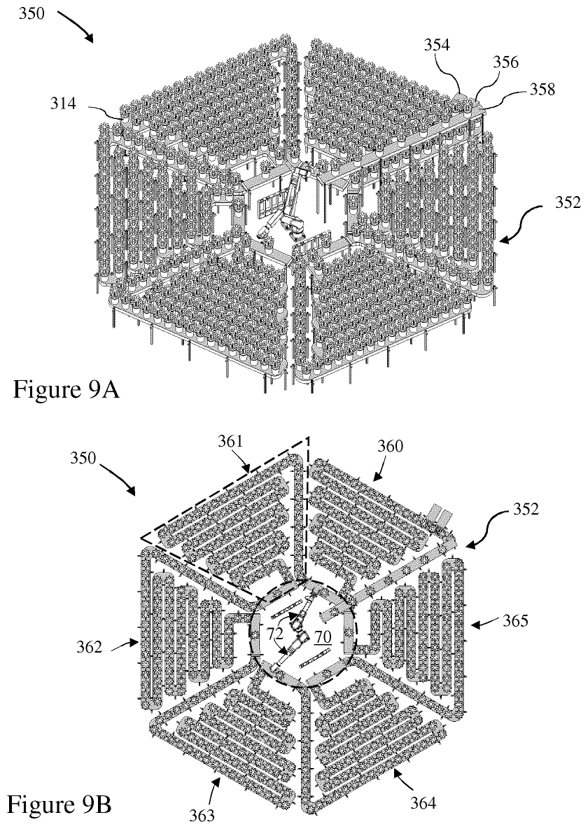

Referring to FIGS. 9A and 9B a perspective and a top view of another embodiment of a farming system is shown generally at 350. The system 350 comprises a closed-loop conveyor system 352 in a general hexagonal shape, configured to gradually cycle and store a plurality of potted plants 314. The conveyor system 352 may be configured to facilitate growth and processing of the potted plants 314 according to a plant's designated growth stage, for example. The conveyor system 352 comprises six trapezoidal growing zones 360 to 365 arranged around a central processing zone 370 located at the center of the conveyor system 352. One or more robotic arms 372 are located in the processing zone 370, and may be configured to perform at least one process on potted plants 314 as they pass through the processing zone 370.

The closed-loop conveyor system 352 may carry each potted plant 314 through the central processing zone 370 while the plant is transiting from one growing zone to the neighboring growing zone, or may carry the potted plants 314 to the processing zone 370 and back to the growing zone. In either case, a potted plant 314 is carried through the processing zone 370 by the closed-loop conveyor system 352 every time it is fully passed through a growing zone such as zone 360. The system 350 further comprises a loading station 354 configured to feed in potted plants to the conveyor system 352 and an unloading station 356 configured to unload potted plants from the conveyor system 352. The system 350 may further include an elimination station 358 separate from the unloading station, configured to temporarily or permanently send out potted plants from the conveyor system 352. The elimination station 358 may be coupled to the central processing zone 370 and accessible to the robotic arms 372 such that if the state of a potted plant is determined to be defective, a robotic arm 372 may dispose of the defective potted plant by moving the plant to the elimination station 358. In some embodiments, the unloading station 356 may be the same as the elimination station 358. In other embodiments, the loading station 354 may be reversible and may also be the unloading station 356 and/or elimination station 358.

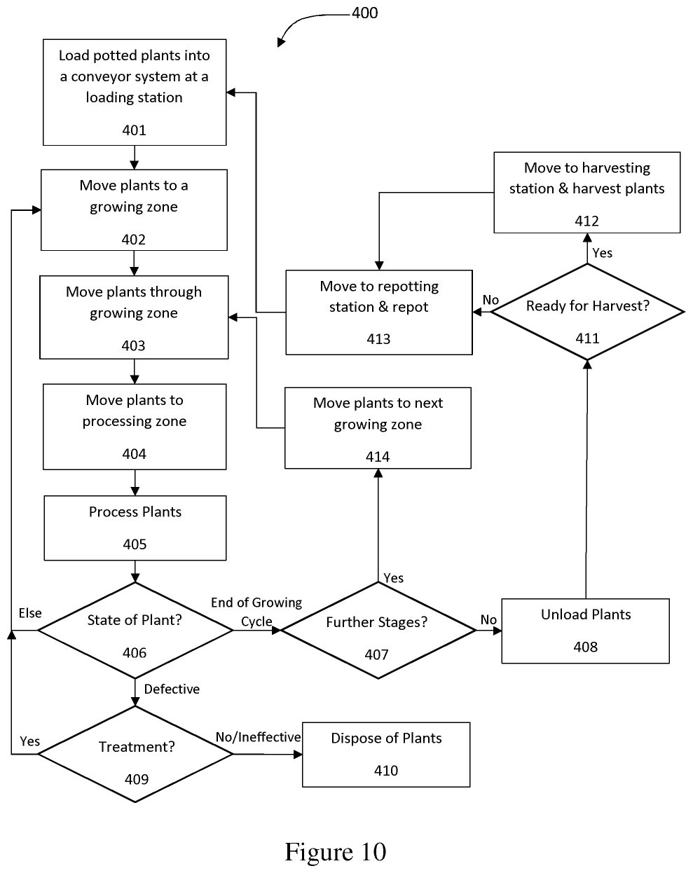

Referring to FIG. 10, a flow diagram depicting a method of automated farming is shown generally at 400. The method 400 begins at a loading step 401, where a plurality of potted plants are loaded onto a conveyor system of an automated farming system at a loading station. The conveyor system may be a closed-loop conveyor system, such as the system described in FIG. 1, for example. The plants are then moved into a growing zone in step 402, which may be configured for storage and growth of plants located within the zone. For example, the growing zone may comprise a series of connected conveyor lines which move slowly and are arranged in a compact, multi-level fashion. In the moving step 403, the plants move through the growing zone. The speed and length of the growing zone may be configured to conform to specific requirements of the plant's life cycle and growing time. For example, the speed and length of the growing zone may be configured such that after the moving step 403, a plant has grown from one stage of its life cycle to another. After moving through the growing zone, the plants move to the processing zone in step 404, and are then processed in the processing zone in processing step 405. Processing the plants in processing step 405 may include trimming the plants, watering the plants, fertilizing the plants, or measuring one or more properties of the plant. Properties of the plant that may be measured during the processing step include the plant's health, amount of growth, growing medium properties such as moisture and fertilizer levels, or any other properties of the plant. These properties may be measured by one or more sensors located at the processing zone, such as cameras and other probes mounted on robotic arms. The sensors may communicate with a processor or controller such as a cloud server and transmit the measured properties, allowing the processor to determine the state of the plant in determination step 406.

In this example embodiment, the processor may determine that a plant's state is at the end of the growing cycle for the given growing zone, in which case the method proceeds to assessment step 407, wherein the processor assesses whether or not there are further growing stages or cycles for the given plant. If there are additional cycles, such as in a system similar to the one in FIG. 8A for example, the processor may then direct the plants to the next growing zone in step 414. If there are no additional cycles, the processor may then direct the plants to be unloaded at an unloading station in step 408. After being unloaded from the conveyor system, the plants may then be assessed by the processor to determine the reason for not having further cycles in analysis step 411, such as whether or not the plants are ready for harvest. If the plants are not ready to be harvested, the reason for not having further cycles may be that the plants need to be moved into larger pots, in which case the plants are taken to a repotting station and repotted in step 413 before being loaded into a conveyor system again at step 401. If the plants are ready for harvest, they are sent to a harvesting facility in step 412 and harvested, after which the pots of the harvested plant may be used for repotting, for example. Back in the determination step 406, the processor may also determine that a plant is defective due to the plant being diseased or damaged, for example. In such a case, treatment of the plant may be attempted in treatment step 409. If treatment is available and effective, the plant may be returned to the growing zone in step 402 for a further cycle. If no treatment is available or the treatment is ineffective, then the plant may have to be removed or disposed of in disposal step 410, where the plant may be taken to an elimination station to be unloaded from the conveyor system, then disposed of in order to prevent cross-contamination of other plants, for example. Otherwise, if the plants are determined in determination step 406 to both not be defective nor at the end of the growing cycle, then the plants are still within the growing cycle and are sent back into the growing zone at step 402.

While specific embodiments have been described and illustrated, such embodiments should be considered illustrative only and not as limiting the disclosed embodiments as construed in accordance with the accompanying claims.

1-36. (canceled)

37. A system for automated farming of potted plants, the system comprising:
a closed-loop conveyor system configured to facilitate gradual cyclic mobility and storage of a plurality of potted plants;
at least one centralized processing zone disposed along the conveyor system and configured to perform at least one operation on each individual pot, the processing zone comprising at least one sensor configured to detect at least one property of a potted plant;
a processing unit in communication with the at least one sensor, the processing unit configured to determine a state of each potted plant based on the at least one detected property, wherein the state describes a physical state of the potted plant;
at least one loading station coupled to the conveyor system and configured to feed potted plants to the conveyor system; and
at least one unloading station coupled to the conveyor system and configured to unload potted plants from the conveyor system.

38. The system of claim 37, wherein each potted plant is equipped with a unique identifier tag to assist tracking each plant and facilitate individualized attention.

39. The system of claim 37, wherein the state of the potted plant includes one of the beginning of a growth period, the middle of a growth period, a defective state, and the end of a growth period.

40. The system of claim 37, wherein the processing zone comprises at least one of:
at least one articulated robotic arm equipped with at least one end effector; and
at least one processing station equipped with at least one end effector;
and wherein each end effector is configured to perform a task on the potted plants.

41. The system of claim 40, wherein the at least one processing station comprises a tunnel along the closed-loop conveyor system and at least one end effector is disposed on the inside of the tunnel to perform at least one process on each individual potted plant.

42. The system of claim 37, wherein the system further comprises networking hardware configured to facilitate communication between the processing unit and a server.

43. The system of claim 42, wherein the server comprises a cloud-based server located at a remote facility, the cloud-based server further configured to communicate with one or more farming systems.

44. The system of claim 43, wherein:
data related to the processing of each potted plant is transferred and collected on the server; and
the server causes a controller to send command inputs to actuators of the processing zone to control the processing of each individual potted plant.

45. The system of claim 44, wherein a comprehensive record related to the processing of each potted plant during the growth period, is created and stored on the server.

46. The system of claim 45, wherein, for a given type of plant during a designated growth period, an optimized growth pattern is determined by the server by analyzing the processing records of a plurality of potted plants of one or more farming systems.

47. The system of claim 37, wherein the conveyor system comprises of a plurality of growing zones and a single central processing zone.

48. The system of claim 47, wherein the conveyor system is configured to transport a potted plant through the central processing zone before the plant is transported from a growing zone of the plurality of growing zones to a subsequent growing zone of the plurality of growing zones.

49. The system of claim 47, wherein each growing zone is configured to have different environmental parameters.

50. A multi-stage farming system for automated farming of potted plants, the system comprising:
a plurality of the automated farming systems in accordance with claim 37, each system configured for one or more stages in a plant's growth cycle;
one or more processing facilities; and
a plurality of transport routes between the automated farming systems and processing facilities, the transport routes configured to carry potted plants.

51. The multi-stage farming system of claim 50, wherein each farming system is configured to have different environmental parameters.

52. The system of claim 37, wherein the closed loop conveyor system comprises a plurality of closed-loop conveyor systems, each closed-loop conveyor system comprising a growing zone and a processing zone, and wherein the processing unit comprises one central processing unit disposed in a common area between the plurality of conveyor systems such that the processing can act as the processing zone of each of the conveyor systems.

53. The system of claim 52, wherein the at least one loading station comprises one of:
a loading station located on each closed-loop conveyor system; or
a central loading station located in the central processing zone configured to distribute potted plants among each closed-loop conveyor system.

54. A method for automated farming, the method comprising:
loading, at a loading station, a plurality of potted plants whose state is beginning of a designated growth period, to a closed-loop conveyor system;
driving each potted plant on the conveyor system to cycle through the closed-loop conveyor system;
performing, at the at least one processing zone, farming operations on the potted plants while the pots are cycling through the conveyor system;
determining, at the at least one processing zone, a state for each potted plant; and
unloading, at an unloading station, a potted plant from the conveyor system based on at least the determined state.

55. The method of claim 54, wherein, when the determined state indicates that the plant is defective, the method further comprises:
identifying, by a processing unit, if there is any available treatment inside the processing zone for the defective plant;
performing the available treatment inside the processing zone on the defective plant if there is an available treatment;
determining, by the processing unit, once treatment is performed whether the plant should continue cycling through the conveyor system; and
unloading the defective potted plant from the conveyor system at the unloading station if there is no available treatment in the processing zone or if it is determined that the plant cannot continue cycling on the conveyor system despite treatment.

56. The method of claim 55, further comprising:
performing treatment on the defective plant outside the conveyor system; and
loading, at the loading station, the treated plant back into the conveyor system after successful treatment.

57. The method of claim 54, further comprising loading, further potted plants whose state is beginning or middle of a designated growth period at the loading station onto the closed-loop conveyor system if the system has additional capacity.

58. The method of claim 54, wherein performing farming operations comprises:
attaching, by a robotic arm, to an end effector;
engaging, by the robotic arm, with an incoming potted plant;
performing, by the robotic arm, one or more tasks on the potted plant corresponding to the attached end effector of the robotic arm; and
detecting, by a sensor on the robotic arm, at least a property of the potted plant.

59. The method of claim 58, wherein determining the state for each potted plant comprises:
identifying, by a processing unit, the state associated with a potted plant based on at least the detected property; and
assigning, by the processing unit, the identified state with an identifier of the potted plant.

60. The method of claim 54, wherein driving each potted plant on the conveyor system to cycle through the closed-loop conveyor system comprises transporting each plant through a first growing zone and further comprising:
transporting the plant through a central processing zone before transporting the plant to a next growing zone;
performing, at the central processing zone, one or more farming operations including determining, by a processor, a state for each potted plant;
determining, by the processor, if a potted plant should continue cycling through the conveyor system based on the determined state;
transporting, by the conveyor system, the potted plant through the next growing zone if the processor determines the plant should continue cycling through the conveyor system; and
wherein unloading a potted plant from the conveyor system based on at least the determined state comprises unloading the potted plant if the processor determines the plant should not continue cycling through the conveyor system.

61. A method for multi-stage automated farming, the method comprising:
preparing pots at a potting stage system;
transporting and loading the prepared pots to a sowing stage system, the sowing stage system configured to sow seedlings in the prepared pots;
unloading the sowed pots from the sowing stage system and transporting and loading the sowed pots to a growing zone of a first growth stage system having a first closed-loop conveyor system;
performing, at the at least one processing zone of the first growth stage system, farming operations on the potted plants including determining a state for each potted plant;
unloading potted plants from the first growth stage system based off of at least the determined state;
transporting and loading potted plants to a growing zone of a second growth stage system having a second closed-loop conveyor system;
performing, at the at least one processing zone of the at least one other growth stage system, farming operations on the potted plants including determining a state for each potted plant;
unloading potted plants from each of the at least one other growth stage system based off of at least the determined state; and
transporting each unloaded potted plant to a destination facility.

62. The method of claim 61, further comprising:
transporting a potted plant to the potting stage system after unloading from the first growth stage system; and
repotting the potted plant at the potting stage system before transporting the potted plant to the second growth stage system.

63. The method of claim 61, wherein the destination facility is a harvesting stage system, and wherein the method further comprises:
harvesting the plant at the harvesting stage system;
sending the harvested plants to a shipping and storage unit; and
transporting and loading the remaining pots from the harvesting stage system back to potting stage system.

64. The method of claim 61, further comprising:
performing a first harvesting process on a potted plant in a processing zone of a growth stage system;
returning the potted plant to the at least one growing zone of the growth stage system; and
performing at least one other harvesting process on the potted plant, before unloading the pot from the growth stage system.
